(19) United States
(12) Patent Application Publication
(10) Pub. No.: US 2003/0122768 A1
(43) Pub. Date: Jul. 3, 2003

(54) Antiferroelectric liquid crystal devices

(76) Inventors: Jose Manuel Oton, Madrid (ES); Xabier Quintana, Madrid (ES)

Correspondence Address: Martin Fleit, Fleit Kain Gibbons Gutman & Bongini, Courvoisier Centre II, 601 Brickell Key Drive Suite 404, Miami, FL, 33131, US

(21) Appl. No.: 10/182,070

(22) PCT Filed: Jan. 26, 2001
(86) PCT No.: PCT/IB01/00169

(30) Foreign Application Priority Data
Jan. 26, 2000 (GB) 0001802.8

(51) Int. Cl. G09G 3/36

(52) U.S. Cl. 345/96; 345/95

(57) ABSTRACT

A drive system for, and method of driving, an antiferroelectric liquid crystal display device (10) that has an array of addressable pixels, each of which is defined between a pair of electrodes. The system comprises a voltage generation means operable to apply the following sequence of monopolar voltage pulses (1 to 7) to at lease one of the pair of electrodes which define at least one selected pixel of the display device (10):

(a) a first selection pulse (1) operable to drive the selected pixel to a first activated state;

(b) a first bias pulse (2) operable to cause the selected pixel to attain a predetermined grey scale level;

(c) a first erasure pulse (3) of opposite polarity to that of the first selection pulse (1) and operable to erase the memory of selected pixel and to switch the pixel to a relaxed inactive state;

(d) a reset pulse (4) operable to allow the pixel to reset in the relaxed state;

(e) a second selection pulse (5) of opposite polarity to that of the first selection pulse (1) operable to switch the selected pixel to a second activated state;

(f) a second bias pulse (6) operable to cause the selected pixel to attain a predetermined grey scale level;

(g) a second erasure pulse (7) of opposite polarity to that of the second selection pulse (5) operable to cause the selected pixel to switch to the relaxed inactive state and erase the memory of the pixel; and

(h) a reset pulse (8) operable to allow the pixel to reset in the relaxed state.

This invention relates to liquid crystal devices and in particular to antiferroelectric liquid crystals (AFLC). This invention is particularly concerned with methods of driving in-state antiferroelectric liquid crystal devices (TSAFLCs) and “Thresholdless” antiferroelectric liquid crystals (TLAFLCs).

In a conventional liquid crystal display device of the passive matrix type, a liquid crystal is sandwiched between two closely spaced (typically 1 to 1.5 μm) plates, at least one of which, (the front plate), is optically transparent. Each plate is provided with a crystal alignment layer and a light polariser. An array of pixels is defined by regions of overlap of two mutually orthogonal arrays of electrodes; one set of which is located on one side of the liquid crystal and the other of which is located on the other side. Individual pixels are switched between an active state (where the molecules of the liquid crystal are aligned so as to permit light to pass through the liquid crystal), to a relaxed state, (where the molecules are aligned so as to obturate the passage of light through the liquid crystal) by applying appropriate voltage pulses to selected rows and columns of the electrodes. Such devices may be illuminated by means of ambient light, or an artificial light source, from behind or from in front of the device. In the case of a front lit device, a reflective layer is provided on the back of the device so as to reflect the light back through the liquid crystal.

The present invention is also applicable to silicon back-plane liquid crystal device. These are devices in which the liquid crystal is sandwiched between a reflective silicon back plane and an optically transparent front sheet. The silicon back plane and the front sheet are provided with a crystal alignment layer and a light polariser. Conventionally these devices are illuminated from the front. The silicon back plane comprises an array of FETs (field effect transistors) each of which comprises the usual gate, drain and collector electrodes and each FET is individually addressable. The front sheet is provided either with an optically transparent sheet electrode (typically made of Indium tin oxide (ITO) or an array, or pattern, or parallel electrodes. An array of pixels is defined by the overlap between the individual FETs and the front electrode, or electrodes. Individual pixels are switched between an active state (where the molecules of the liquid crystal are aligned so as to permit light to pass through the liquid crystal), to a relaxed state (where the molecules of the liquid crystal are aligned so as to obturate the light passing through the liquid crystal) by applying appropriate voltages to selected FETs and the front electrode, or electrodes. Here again such devices may be illuminated from the front by means of ambient light, or an artificial light source, and the reflective silicon back plane reflects light back through the liquid crystal.

“Tristate” AFLCs are those in which the electro-optical resonse of the liquid crystal exhibits three stable states, namely two activated states (each of which depends upon the polarity of the applied selection pulses), where the molecules of the liquid crystal are aligned so as to permit light to pass through the liquid crystal, and an inactive state, usually called “a Relaxed State”, where the selection pulse is at a voltage level at which the molecules are aligned to obturate the passage of light through the liquid crystal.

“Thresholdless” antiferroelectric liquid cyrstals are those in which the electro-optical response of the liquid crystal exhibits three stable states, namely two activated state (each of which depends upon the polarity of the applied selection pulses), where the molecules of the liquid crystal are aligned so as to permit light to pass through the liquid crystal, and an inactive state, usually called “a Relaxed State”, where the selection pulse is at zero volts and the molecules are aligned to obtruate the passage of light through the liquid crystal.

One way of obtaining a colour display, both the passive matrix devices and silicon back-plane devices, is to illuminate them sequentially with red, green and blue light whilst selected pixels are activated or switched off.

Grey scale levels, that is to say various shades of contrast, are obtained by switching the pixels to intermediate levels where the molecules of the liquid crystal are aligned so as to permit varying levels of partial transmissivity of light through the liquid crystal.

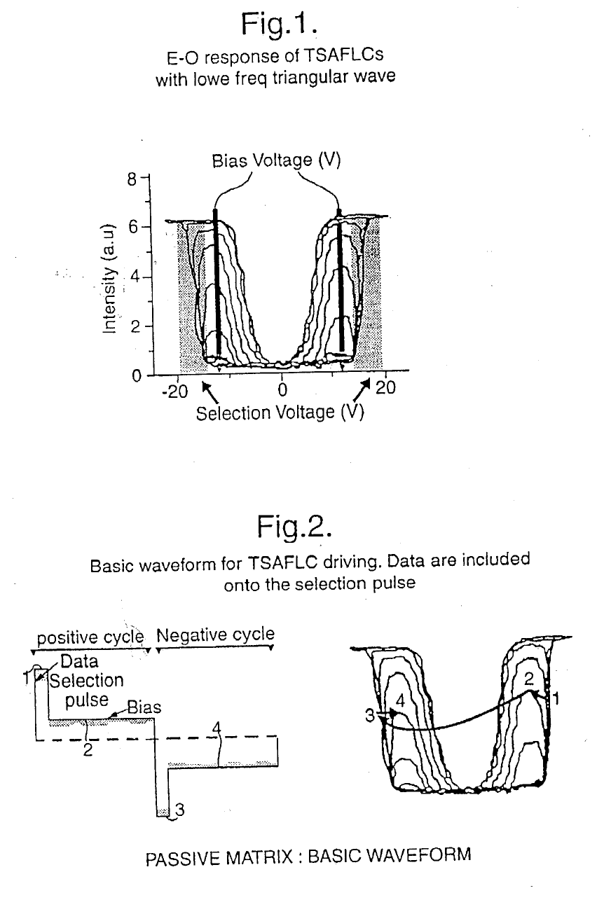

A typical electro-optical response (transmissivity of light through the liquid crystal plotted against voltage applied across the liquid crystal), obtained when a TSAFLC is subjected to a series of monopolar voltage pulses (of voltage v, and pulse width t), separated by a time period (typically 10 to 100 t), is show, schematically in FIG. 1. The value of v and t of the selection pulses are chosen such that latching into one of two activated (or saturated) states is achieved depending on the polarity of the pulse. When the voltage is removed, (zero volts) the liquid crystal tends to assume a relaxed inactive State. As will be seen from FIG. 1, the electro-optic response is typically a double hysteresis loop.

The simplest waveform that can be used to drive TSAFLC materials having an electro-optical response as shown in FIG. 1, is shown in FIG. 2. If greyscale levels are required, the liquid crystal requires to be driven by selection pulses of positive or negative voltages (by which the outer slope of the hysteresis loop is reached), and positive or negative voltage “holding”, or “biasing”, pulses 2, 4, to maintain the pixel grey scale levels along the timeframe. Data are included in the selection pulses 1, 3. Such a simple waveform can be used to multiplex passive matrix type AFLCs.

There are three identifiable states in TSAFLC hysteresis loops; the relaxed state at zero volts and two symmetric ferroelectric activated, or saturated, states at the outer ends of the hysteresis loops (±V). The waveforms for passive matrix displays should include these three states in every cycle. The simple waveform of FIG. 2 cannot be used without modification for TSAFLC materials. This is because TSAFLCs show a memory effect, by which the grey scale level of each selected pixel achieved in one cycle, depends on that achieved in previous ones. To avoid this undesirable effect, the “memory” of each selected pixel has to be “erased” by bringing it to a known state (always the same) before every cycle.

Several waveforms have been proposed in the past for enabling the erasure of the “memory” of pixels. Prior known erasure schemes generally fall into two main categories; those that allow the pixel to attain a Relaxed State of the AFLC, and those that make use of one of the Saturation States to erase the “memory” of the pixel. It is generally accepted that relaxation schemes produce better greyscales compared with saturation schemes, but saturation schemes are faster and better suited towards video applications.

An object of the present invention is to provide a drive scheme for driving tri-state or thresholdless antiferroelectric liquid crystal devices which uses a voltage well pulse to force selected regions of the liquid crystal to a Relaxed State and thereby reduce substantially the reset times compared with prior known schemes.

According to one aspect of the invention there is provided a method of driving an antiferroelectric liquid crystal display device which has an array of addressable pixels, each of which is defined between a pair of electrodes, the method comprising the steps of applying the following sequence of monopolar voltage pulses to at least one of the pair of electrodes which define at least one selected pixel:

(a) a first selection pulse operable to drive the selected pixel to a first activated state;

(b) a first bias pulse operable to cause the selected pixel to attain a predetermined grey scale level;

(c) a first erasure pulse of opposite polarity to that of the first selection pulse operable to erase the memory of selected pixel and to switch the pixel to a relaxed inactive state;

(d) a reset pulse operable to allow the pixel to reset in the relaxed state;

(e) a second selection pulse of opposite polarity to that of the first selection pulse operable to switch the selected pixel to a second activated state;

(f) a second bias pulse operable to cause the selected pixel to attain a predetermined grey scale level;

(g) a second erasure pulse of opposite polarity to that of the second selection pulse operable to cause the selected pixel to switch to the relaxed inactive state and erase the memory of the pixel; and

(h) a reset pulse operable to allow the pixel to reset in the relaxed state.

In a further aspect of the invention there is provided a drive system for an antiferroelectric liquid crystal display device that has an array of addressable pixels, each of which is defined between a pair of electrodes, the system comprising voltage generation means operable to apply the following sequence of monopolar voltage pulses to at least one of the pair of electrodes which define at least one selected pixel of the display device:

(a) a first selection pulse operable to drive the selected pixel to a first activated state;

(b) a first bias pulse operable to cause the selected pixel to attain a predetermined grey scale level;

(c) a first erasure pulse of opposite polarity to that of the first selection pulse operable to erase the memory of selected pixel and to switch the pixel to a relaxed inactive state;

(d) a reset pulse operable to allow the pixel to reset in the relaxed state;

(e) a second selection pulse of opposite polarity to that of the first selection pulse operable to switch the selected pixel to a second activated state;

(f) a second bias pulse operable to cause the selected pixel to attain a predetermined grey scale level;

(g) a second erasure pulse of opposite polarity to that of the second selection pulse operable to cause the selected pixel to switch to the relaxed inactive state and erase the memory of the pixel; and,

(h) a reset pulse operable to allow the pixel to reset in the relaxed state.

In yet a further aspect of the invention there is provided a antiferroelectric liquid crystal; device that has an array of addressable pixels, each of which is defined between a pair of electrodes, the device including a drive system comprising a voltage generation means operable to apply the following sequence of monopolar voltage pulses to at least one of the pair of electrodes which define at least one selected pixel:

(a) a first selection pulse operable to drive the selected pixel to a first activated state;

(b) a first bias pulse operable to cause the selected pixel to attain a predetermined grey scale level;

(c) a first erasure pulse of opposite polarity to that of the first selection pulse operable to erase the memory of selected pixel and to switch the pixel to a relaxed inactive state;

(d) a reset pulse operable to allow the pixel to reset in the relaxed state;

(e) a second selection pulse of opposite polarity to that of the first selection pulse operable to switch the selected pixel to a second activated state;

(f) a second bias pulse operable to cause the selected pixel to attain a predetermined grey scale level;

(g) a second erasure pulse of opposite polarity to that of the second selection pulse operable to cause the selected pixel to switch to the relaxed inactive state and erase the memory of the pixel; and,

(h) a reset pulse operable to allow the pixel to reset in the relaxed state.

The first and second bias pulse may be of the same polarity as, but lower voltage than, respectively, the first and second selection pulses.

The first and second bias pulse may be of higher voltage than, respectively, the first and second selection pulses.

The reset pulses are at zero volts.

Data for the selected pixel is incorporated with the first and second selection pulses, or incorporated with the first and second bias pulses.

Preferably the display device is a passive matrix display device, and one of the electrodes of each pair of electrodes is constituted by one electrode of a first array of electrodes, and the other electrode of each pair is constituted either by an electrode common to all pairs of electrodes, or one electrode of a second array of electrodes, and the said pulses are applied sequentially to selected electrodes.

A first electrode of the pair of electrodes may be maintained at a predetermined datum voltage level relative to the second electrode of the respective pair of electrodes, and the selection pulses, bias pulses, and erasure pulses are applied to the second electrode of the pair of electrodes.

A method according to claim 8, wherein the selection pulses and the bias pulses are applied to a first electrode of the pair of electrodes.

Alternatively, the display device comprises an antiferroelectric liquid crystal material sandwiched between a reflective backplane comprising an array of addressable Field Effect Transistors (FETs), and one or more counter electrodes, thereby to define an array of addressable pixels, and the pulses are applied to one or more selected FETs and to the one or more counter electrodes thereby to drive selected pixels between an active state and the relaxed state.

The selection pulses, bias pulses, erasure pulses and reset pulses are preferably applied to selected FETs, and monopolar voltage first and second pulses are applied simultaneously to the counter electrode.

Preferably, first pulse applied to the counter electrode has a pulse width that spans the combined pulse widths of the first selection pulse, the first bias pulse, the first erasure pulse, and the first reset pulse.

Preferably, the second pulse applied to the counter electrode has a pulse width that spans the combined pulse widths of the second selection pulse, the second bias pulse, the second erasure pulse and the reset pulse.

The present invention will now be described, by way of examples, with reference to the accompanying drawings in which:

FIG. 1 shows schematically, a typical electro-optical response of a known antiferroelectric liquid crystal device (AFLC) and is provided for reference purposes;

FIG. 2 shows a typical prior known simple waveform for driving an AFLC to produce the electro-optical response shown in FIG. 1;

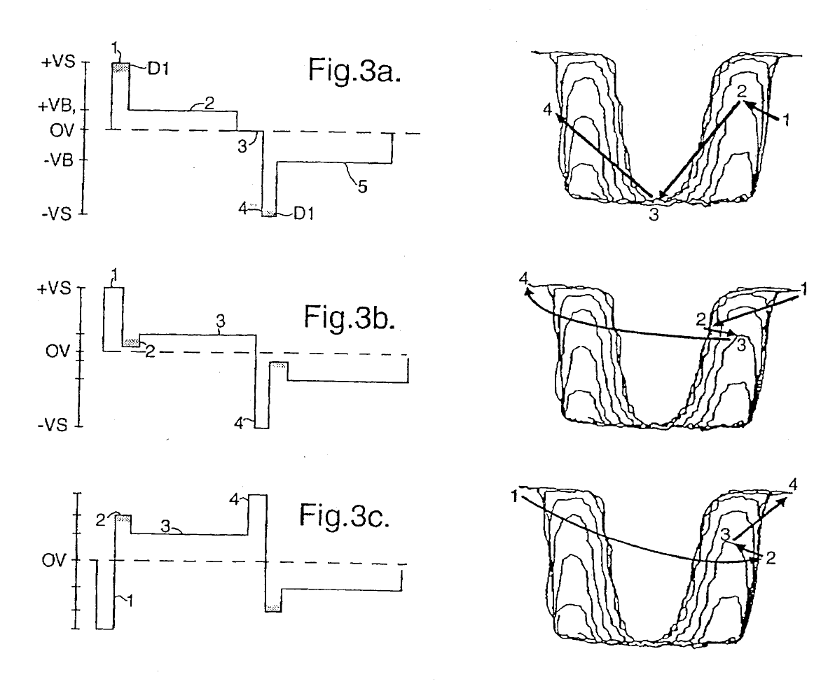

FIGS. 3(a), 3(b) and 3(c) show, schematically, various prior known waveforms for driving AFLC devices to produce greyscale levels and erase the “memory” of selected pixels;

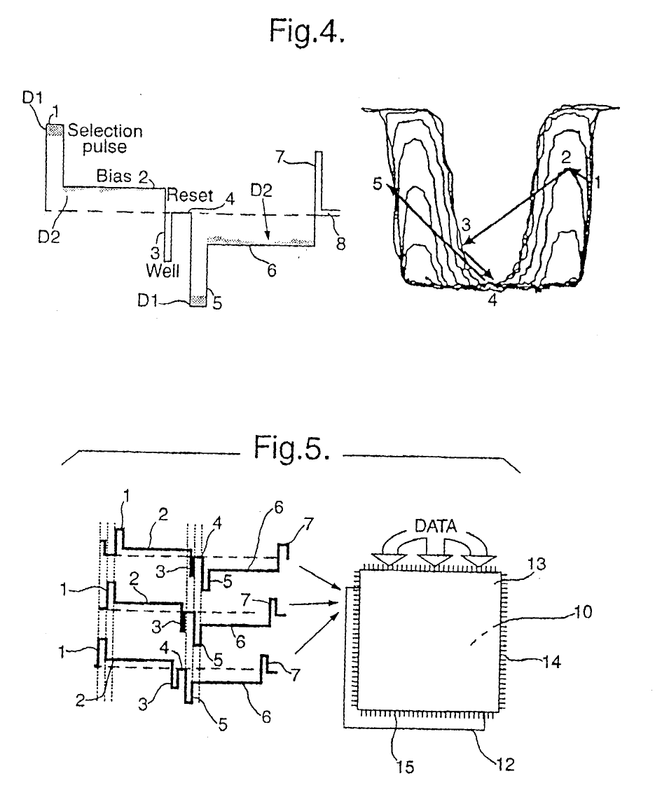

FIG. 4 shows a simple waveform incorporating the present invention for driving a TSAFLC device;

FIG. 5 shows the application of a driving waveform incorporating the present invention for driving a TSAFLC passive matrix display device; and

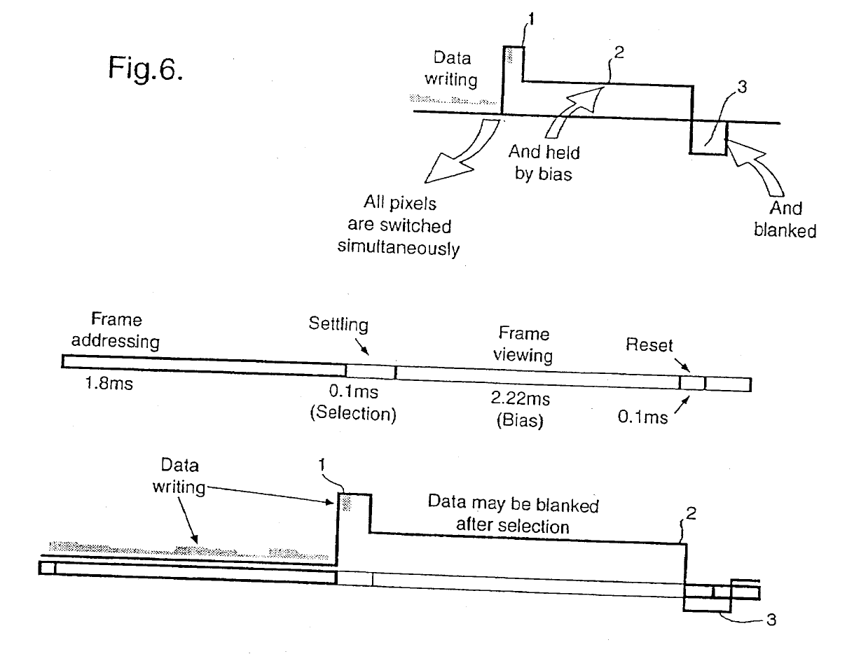

FIG. 6 shows the application of a driving waveform incorporating the present invention for driving a TSAFLC silicon backplane device.

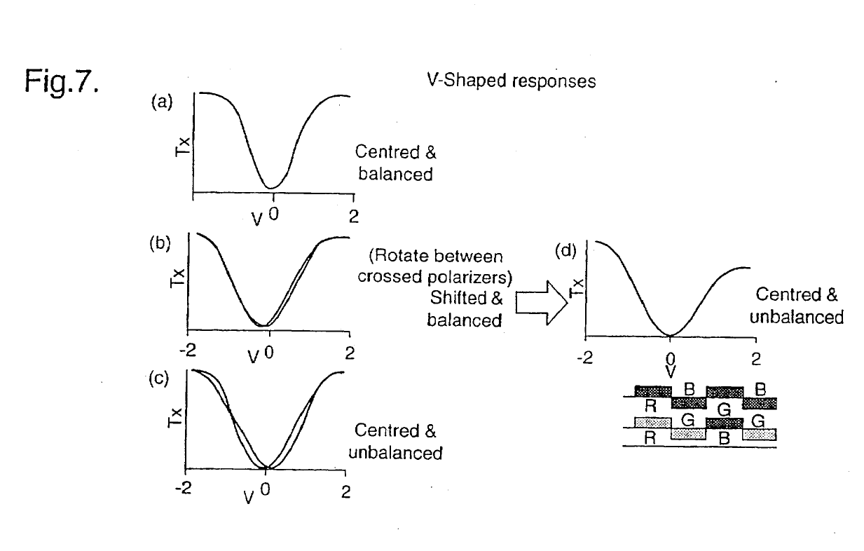

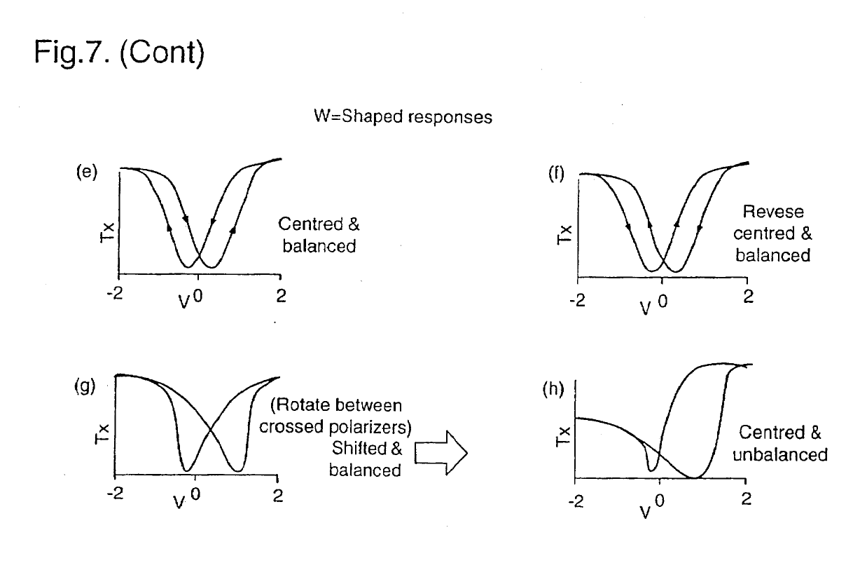

FIG. 7 shows the typical electro-optical response of thresholdless AFLCs so called “V shape” or “W shape” AFLCs (sometimes called “thresholdless AFLCs).

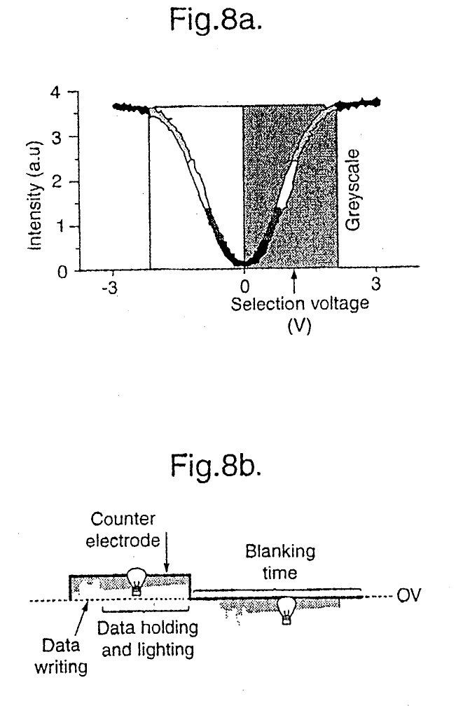

FIG. 8(a) the electro-optical response of an almost ideal V shaped sample.

FIG. 8(b) shows schematically a simple waveform in accordance with the present invention for driving an AFLC having an electro optical response shown in FIG. 8(a).

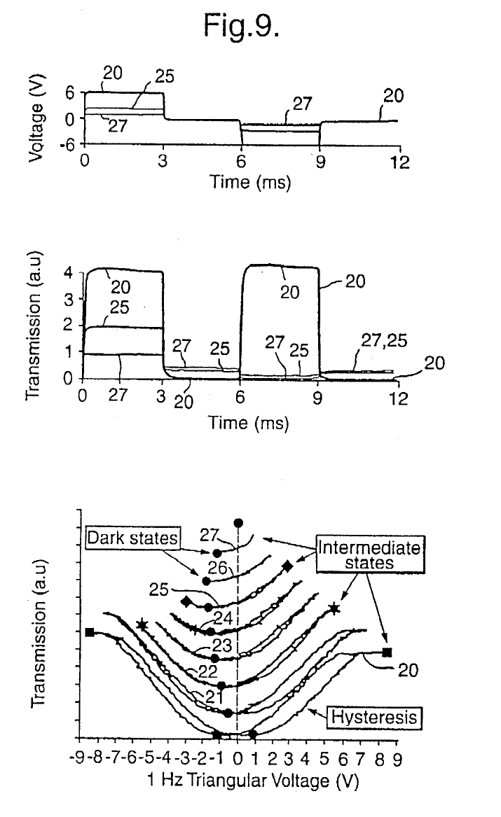

FIG. 9 shows several hysteresis curves for various TLAFLCs having W shaped electro-optic responses.

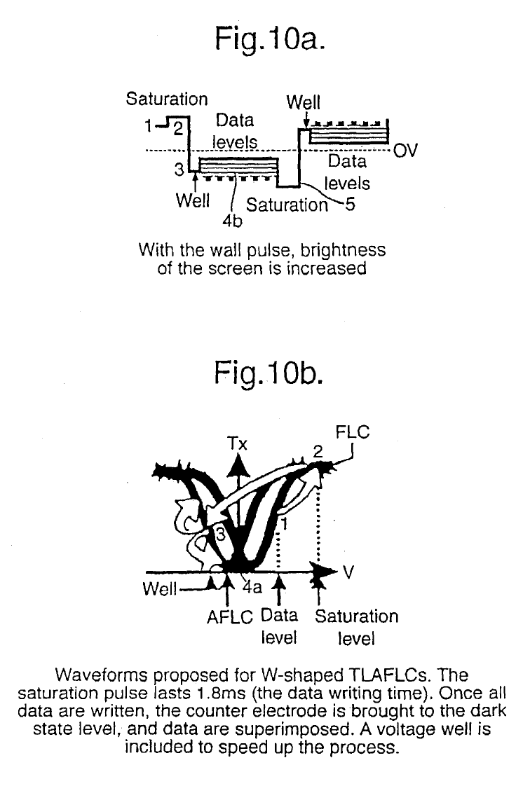

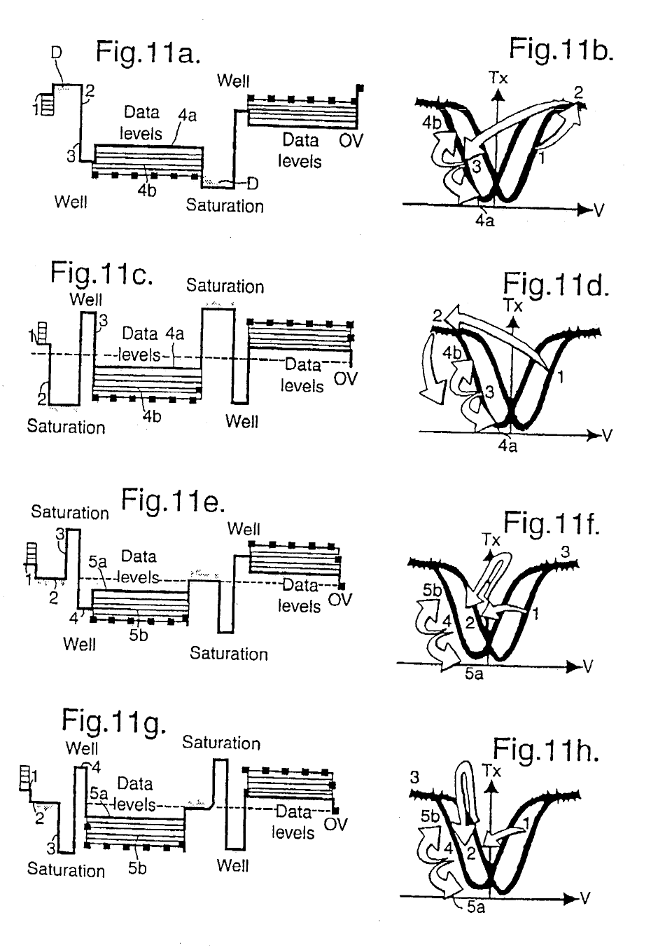

FIG. 10 shows

Referring to FIG. 1 there is shown a typical electro-optical response obtained when a transmission type of AFLC device is subjected to a series of monopolar voltage pulses 1,3, of voltage, v, and pulse width t, separated by a time period (typically 10 to 100 t). As will be seen, the electro-optic response (light transmissivity plotted against voltage) is typically a double hysteresis loop.

The values of v and t are chosen such that latching of the liquid crystal into one of two activated (or saturated) states is achieved depending on the polarity of the pulse. When the voltage is removed, (shown in the drawing as a zero volts pulse, 2), the liquid crystal tends to assume a relaxed or inactive statestate.

The simplest waveform that can be used to drive AFLC materials having an electro-optical response similar to that of FIG. 1, is shown in FIG. 2. If a greyscale level is required for each pixel. AFLC requires to be driven by monopolar selection pulses 1,3, of positive or negative voltages respectively, by which the outer slope of the hysteresis loop is reached, in order to switch the AFLC to the activated state. The AFLC also requires positive or negative voltage “holding”, or “biasing”, pulses 2, 4 respectively, to maintain the grey level scales of selected pixels along the timeframe. Data are included in the selection pulses 1 and 3.

Such a simple waveform can be used to multiplex passive matrix type AFLCs. However, this simple waveform cannot be used without modification for TSAFLC materials, since TSAFLCs show a memory effect, by which, the grey scale level achieved in one cycle, depends on that obtained during the previous cycle. To avoid this undesirable effect, the “memory” of each pixel has to be “erased” by bringing it to a know state (always the same) before every cycle.

Referring to FIG. 3(a) there is shown a typical prior known waveform for driving a TSAFLC, that uses relaxation of the AFLC to erase the “memory” of each pixel. The waveform comprises a series of monopolar voltage pulses 1 to 5, in which the TSAFLC material is driven from the relaxed state (V=0 volts) to the activated, or saturation, state by applying a positive voltage selection pulse 3, 5 of +Vₛ volts. Greyscale level is achieved by applying a positive bias voltage +V_{B1} volts (pulse 2). The TSAFLC is allowed to assume a relaxed state by dropping the voltage to zero volts (pulse 3). The TSAFLC is then driven to the second activated, or saturated, state by applying a negative voltage pulse 4, of −Vₛ volts. Greyscale level is obtained by applying a negative bias voltage (pulse 5) of −V_{B}, volts. Data D₁ are input in the selection pulses 1 and 4.

It will be seen that the waveform of FIG. 3(a) includes a reset time to allow the pixel to relax. However, most of the TSAFLC materials of interest for display devices, have relaxation times of many milliseconds (typically greater than 5 milliseconds) and this is comparable to the whole timeframe of the waveform. Therefore, this simple waveform is unsuitable for driving TSAFLC multiplexed passive matrix display devices.

Referring to FIG. 3(b), there is shown a prior known waveform for driving TSAFLCs, which uses saturation to erase the “memory” of each selected pixel. The waveform comprises a series of monopolar voltage pulses in which the TSAFLC material is driven to an activated, or saturation, state by applying a positive voltage pulse (1) of +Vₛₐₜ, volts to erase the memory of the pixel. A selection pulse (2) of +Vₛₑₜ volts is applied to drive the TSAFLC to an activated or saturation state and a positive pulse (3) of +V_{bias} volts is applied to obtain the grey scale levels. The TSAFLC material is then driven to the second fully saturated state to erase the memory of the pixel by applying a negative voltage pulse (4) of −Vₛₐₜ volts, and a selection pulse (5) of −Vₛₑₜ volts is applied to drive the TSAFLC material to an activated, or saturated, state. Greyscale level is achieved by applying a negative voltage bias of −V_{bias} volts (Pulse 6).

Referring to FIG. 3(c) we have devised a further waveform (so far unpublished) which uses saturation to erase the memory of the selected pixels. The waveform of FIG. 3(c) comprises a series of monopolar voltage pulses (1 to 6). The first pulse 1, is a negative voltage pulse of −Vₛₐₜ volts that drives the TSAFLC to the fully saturated state to erase the memory of the pixels. A positive selection pulse (2) +Vₛₑₜ volts is then applied to switch the TSAFLC to an activated state, and a positive bias pulse (3) of +V_{bias} volts is applied to maintain the desired greyscale level. A positive erasing pulse (4) of +Vₛₐₜ volts is then applied to erase the pixel. A negative selection pulse (5) of −Vₛₑₜ volts is then applied to drive the TSAFLC material to a saturated state, and greyscale levels are maintained by applying a negative voltage bias (pulse 6) of −V_{bias} volts.

The two waveforms of FIG. 3(b) and 3(c), based on saturation to erase the memory of the pixels are fast, but show less satisfactory greyscales compared with the waveform of the present invention.

Referring to FIG. 4, the waveform of the present invention uses forced relaxation as the means of erasing the memory of the pixels. FIG. 4(a) shows the electro-optical response, and FIG. 4(b) shows the drive scheme in accordance with the present invention.

The waveform of FIG. 4(b) comprises a series of monopolar voltage pulses (1 to 7) in which a positive selection pulse 1, of +Vₛₑₜ volts is applied to drive the TSAFLC to the first saturated state. Greyscale levels are achieved by applying a positive voltage bias (pulse 2) of +V_{bias} volts. A voltage well pulse 3, of opposite polarity −V_{well} volts to that of the selection pulse 2, is applied to force the TSAFLC to the relaxed state, and the TSAFLC is held at zero volts (pulse 4) to allow the pixel to reset in the relaxed state. A negative voltage selection pulse 5 −Vₛₑₜ volts is then applied to drive the TSAFLC to the second activated, or saturation state, and a negative voltage bias (pulse 6) of −V_{bias} volts is applied to achieve the desired greyscale level. The selected pixel is forced to the relaxed state by applying a voltage well pulse 7 of opposite polarity +V_{well} volts to that of the selection pulse 5.

We have shown, experimentally, that a correctly designed voltage well pulse 3, or 7, reduces, by up to two orders of magnitude, the relaxation time (e.g., below 100 μs). It will be seen that the waveform of FIG. 4(b) requires seven voltage levels compared with five of FIG. 3(a) in order to enable the amplitude and pulse widths to be freely set.

Referring to FIG. 5, there is shown the application of waveform of FIG. 4(b) for driving a passive matrix display device. The display device 10 is a conventional transmissive type, in which the TSAFLC material 11 is sandwiched between two glass plates 12, 13. Mutually orthogonal arrays of parallel transparent indium tin oxide electrodes 14, 15 respectively on each side of the device, define a matrix of addressable pixels. Data D₁ for each column that is to be addressed in a selected row is incorporated in the selection pulses 1 and 5, and data D₂ for the other columns in the selected row that are not be addressed, is incorporated in the bias pulses 2 and 6.

Rows of the display device are sequentially addressed, and data for each row is written in the columns of the display during their respective time slot. FIG. 5 shows schematically, the use of the waveform of FIG. 4(a) to address three successive columns in a single row. From this it will be seen that in any given row, pixels “see” their own data (D₁) during the selection pulse (pulses 1 and 5), and data (D₂) for other rows during bias and reset times (pulses 2, 3 and 6). By addressing all of the rows in sequence, data (D₁, D2) may be written to all the columns, thereby switching the pixels between their relaxed, state and their activaed, or saturated state. It follows that cross talking may arise if data voltage levels (D₁, D2) are significant compared to the selection and bias voltage levels (pulses 1, 2, 5 and 6). Optimisation of the waveforms and fabrication conditions have enabled us to achieve low dynamic range (<2 to 5V) greyscales, allowing high multiplex levels with low crosstalk.

The waveform of FIG. 4(b) can also be applied to TSAFLCs incorporated in silicon backplane devices. In a Silicon backplate device, (shown schematically in FIG. 6, the TSAFLC material is sandwiched between a transparent front sheet 15, transparent indium tin oxide electrode 16 over its surface (or an array of parallel electrodes, and a reflective silicon backplane 17 that incorporates an array of FETs (Field effect transistors) In such active devices, data can be made independent of the selection pulses (i.e., no sequential row scanning is required). On the other hand, data wiring takes a substantial fraction (˜40%) of the frametime. The remaining time should be mostly assigned to viewing (lighting); otherwise the display would be dark.

To achieve this time distribution, the possibility of sharing the liquid crystal reset time and the data writing time, has been tested. This can be done because usually the AFLC material threshold is much higher than the highest data levels. In such a scheme (half of a suitable cycle of which is shown in FIG. 6), all data (D₁) are written in advance to the array of FETs during the reset pulse 1, and a single series of pulses (comprising selection pulse 2, bias pulse 3, voltage well pulse 4 and reset pulse 5) is applied to the electrode 16 afterwards. The cell then switches as a whole. The same sequence is repeated for the negative half of the cycle. That is to say, data is written to the FETs during the reset pulse 5 (1-8 ms), and a single series of pulses, comprising a negative selection pulse 0.1 ms (not shown), followed by a negative voltage bias pulse (2-22 ms) (not shown), then a 0.1 ms voltage will pulse (not shown), of opposite (i.e. positive) polarity to that of the bias pulse (to switch the pixels to a relaxed state), is applied to the counter electrode. Data D₂ may be incorporated in the selection pulses.

The drive scheme of FIG. 6 has a decisive advantage: All pixels have the same chance to switch, relaxation, bias and selection are simultaneous for all pixels. No crosstalk can be produced. Moreover, transmission need not be stabilised within the frametime. Indeed, the AFLC material does not reach a stable transmission, but the integral transmission (during lighting time) for any given grey level is the same for any pixel. Therefore, a simple gamma correction should produce the correct greyscale. We have tested several crucial points in this scheme, and found that:

(a) Data writing during liquid crystal reset (pulses 1 and 5), does not affect the material relaxation of the liquid crystal to the relaxed state

(b) Grey levels are maintained by the bias pulses;

(c) Data are needed only during selection pulses; and,

(d) Once the pixel is switched to the active state, the bias voltage holds the grey level.

This means that:

a) Data may be blanked in the backplane during the bias pulse 3. In this way, all pixels “see” the same applied voltage.

b) The selection pulses 2 may affect stored data D₂. Even so, the grey scale is maintained.

c) If data storage is not affected by selection pulses, and no blanking is applied after the selection pulses, pixels would “see” different voltage levels, depending on their grey levels.

We further found that, the drive scheme of FIG. 6 gives an excellent greyscale, although its dynamic range is obviously different from that described above in respect of FIG. 4(b). We have also found that if the data range is below 2.5 V, no significant differences are found between pixels whose data are written at the beginning and the end of the writing time.

As in the passive matrix display case, the greyscale levels depend on temperature. Fortunately, by increasing the temperature the entire greyscale is shifted parallel to itself. Thus temperature correction, if required, should be achievable by applying a simple DC offset voltage on each cycle.

We further found that, as in the passive matrix display case, grey scale levels obtained in the positive and negative cycles are not the same. If Red-Green-Blue (RGB) frames were alternated between positive and negative cycles, a component with one half-frame rate frequency would appear, and flickering would result. A possible solution to overcome this would be to use the sequences RGBG or RBGB, so that every colour is always represented with either positive or negative frames.

The above discussion does not take into account that data are not bipolar, but are positive values. As a result, the whole waveform of FIG. 6 is shifted towards positive values. This must be taken into account when adjusting the voltage levels of the positive and negative cycles.

The preferred TSAFLC material suitable for use in the present invention, is a commercially available TSAFLC material known as CS-4001 obtainable from a Japanese Company called Chisso K.K. Table 1 sets out typical values which we have found to work well. The exact range of values depend on manufacturing parameters such as alignment layer and thickness of the liquid crystal material.

TABLE 1
WITH THE CS-4001 MATERIAL @ 35° C.
Waveform assumes ˜200 Hz frame rate (˜5 ms frametime).
This takes into account the sequenccs RGBG/RBGB mentioned above.

| | |
|---|---|
| Selection peak: | 20 to 30 Volts |
| Selection time: | 50 to 200 μs (closely linked to previous cycle) |
| Bias level: | 10 Volts |
| Well Voltage: | 8 to 10 Volts |
| Voltage well time: | 50 to 150 μs (closely linked to previous cycle) |
| Greyscale range: | 2 to 3 Volts |

Thresholdless Antiferroelectric Liquid Crystals (TLAFLC), also called “V-shaped antiferroelectric liquid crystals” because their electro-optical response is substantially V shaped, are a very attractive alternative to TSAFLCs. The main advantage over that TLAFLCs have over TSAFLCs is that they require much lower switching voltage, compatible with those required by silicon backplane devices. The main disadvantage is that they have no hysteresis, (hence no possibility of passive matrix addressing). However this does not pose a problem for some applications. There is a subtle further disadvantage, that will be analysed in depth below. A thresholdless material is, by definition, one that will be affected by any voltage level applied across the liquid crystal. Therefore, data cannot be sequentially written in advance and switched altogether, as described above in relation to FIG. 6.

Paradoxically, the electro-optical response of V-shaped LCs is often W-shaped and V-shaped. FIG. 7 shows schematically the different electro-optical responses of TLAFLCs, as well as their feasibility to be addressed with waveforms incorporating the present invention.

From FIG. 7, it will be seen that the electro-optical responses of TLAFLCs may be classified into several categories, namely

(a) V-shaped (FIGS. 7(a) to 7(d)) or W-shaped (FIGS. 7(d) to 7(h)) according to the hysteresis curve obtained. W-shaped materials may be normal (FIG. 7(e)) or reversed (FIG. 7(f)), depending on the followed by the material on the hysteresis curve path (see arrows in FIGS. 7(e) and 7(f)). For convenience here, we use the term “hysteresis curve” for any electro-optical response whether or not it is strictly a hysteresis loop); or

(b) Balanced, (FIG. 7(f)), if the hysteresis branches are symmetric; or

(c) Unbalanced, (FIG. 7(g)), if the hysteresis branches are asymmetric

Some of these features depend on the relative position of the polarisers. One may move a shifted balanced response (FIG. 7(f)) to obtain a centred unbalanced one (FIG. 7(g)), and vice versa. Moreover, the shape is not entirely correlated with the material, or the fabrication conditions. We have found different responses in different areas of the same cell, working at the same conditions. This is obviously an issue to be solved in eventual prototypes, as is common practice in the development of these types of devices.

Most silicon backplane designs particularly those for use in colour display devices, rely on sequential lighting of the display with red, green and blue light. The frame-time is about 5 ms. Under these conditions, the TLAFLC materials do not reach stable grey levels. This goes unnoticed by the human eye, since the integration time of human vision is larger. However, it is important that every pixel is switched in the same way. Specifically, the time elapsed between the switching pulse and the lighting period must be the same for all pixels. Otherwise pixels would be lighter or darker upon illumination, depending on their position in the display. This is a direct consequence of sequential lighting of reflective devices (and short frametime); it does not affect a backlighted direct-view V-shaped FLC display.

FIG. 8(b) is an example of a simple waveform for driving an almost ideal V-shaped sample of the type shown in FIG. 8(a). Writing to the FETs of the silicon backplane takes 1.8 ms, roughly 40% of the frame. The lighting period is 2.2 ms, and the remaining time is used for settling the AFLC material, and for blanking the data applied to the FET array of the backplane. It can be seen that, unless the liquid crystal response is extremely fast, the variable delay in data writing, modifies pixel transmission during the lighting period. Therefore, if sequential lighting is used, and pixel transmission is not stabilised before the light is turned on, a different approach must be employed. We propose in these circumstances to switch all pixels at the same time, after the data writing period. This is easier to accomplish with TSAFLCs than with TLAFLCs because the evistence of a (high) voltage threshold in TSAFLCs avoids premature switching during data writing time. However, with TLAFLCs, unintentional switching cannot be avoided. The solution proposed by us is to saturate every pixel during writing by applying a predetermined square wave voltage 10 to the front electrode of the display device as shown in FIG. 8(b). In FIG. 8(b) the erasure pulses to switch the AFLCD to the relaxed state in accordance with the present invention are applied to the FETs as part of the Data D₁. This is best seen in the waveform of FIG. 10(b) which is similar in concept to the waveform of FIG. 8(b).

Referring to FIG. 8(b), a square wave voltage signal is applied to the counter electrode (front electrode) of the display device simultaneously when writing data D₁, D₂ to selected FETs of the FET array of the back-plane. The polarity of the voltage applied to the counter electrode of the display device selects either the positive or negative side of the electro-optical response V curve.

W-shaped response is often found in TLAFLCs. Although these materials can be used very much like V-shaped materials, extra care must be used in waveform design. The reason is shown in FIG. 9. Several hysteresis cycles for different voltage amplitudes are shown in FIG. 9(c). The curves 20 to 27 are shown vertically shifted for clarity in reality all of them overlap. FIG. 9(b) shows the transmission obtained when applying the voltage signal indicated in FIG. 9(a).

The curve 20 (labelled “hysteresis” in FIG. 9(c) is saturating the cell. W-shaped response is more clearly seen in the bottom curve than in the other curves. Two symmetric minima 28, 29 (dark states) are found in the bottom curve. The transmission of the positive and negative cycles, (FIG. 9(b)) are identical. This is not the case for a non-saturating signal such as that shown by reference numeral 25 (the third curve from top in the hysteresis plot). In this case, the transmission of the positive cycle is higher, since the same inner branch of the hysteresis curve is used for both positive and negative pulses. The negative level 30 is close to the minimum transmission (dark state), its transmission being even lower than the zero volt transmission. The reason for this is that the pixels must be saturated between positive and negative cycles.

As seen above, both V-shaped and W-shaped cells demand saturating pulses for sequential lighting operation. The waveform levels proposed are roughly the same in both cases. FIG. 10 shows the W-shape case. Given a data level 31 (FIG. 10(a)), it is brought to saturation 32 during writing to the FET array. After writing, the counter electrode voltage level is brought to dark level 33, where data are superimposed (33-34). The bottom waveform (FIG. 10(c)) is identical except for a voltage well 35 added to speed up the access to grey levels 36 in accordance with the present invention. The well is calculated so that the time elapsed to teach any level is the same for all pixels.

With the waveform of FIGS. 8, 9 and 10, driving of the counter electrode and the input of data are managed independently. For convenience, both are considered above as if they are symmetric. In actual cases, the data are always positive, rather than bipolar. Therefore, the waveform applied to the counter electrode will have to be shifted accordingly to compensate the data voltage. Another important point is the relationship between stored data voltage, and data voltage remaining after the saturation pulse is removed. One must take into account that data are written to the FET array whilst voltage is applied to the counter electrode. The charge is shared between the existent capacitors in a non-straightforward manner.

If the Cell is V-shaped; the saturating pulses could use either branch of the curve. However if the cell response is W-shaped, only one saturating branch is available to commute between W sides (see FIG. 7). This branch will be either the same branch where the grey level is maintained, or the opposite branch, depending on whether the W-shaped cell has normal or reversed W response. Therefore; the waveform has to be formulated according to the W “circulating sense”.

A different approach to the design of TLAFLC waveforms in silicon back plane devices has been tried. The approach discussed above should be acceptable for many purposes, except for one point discussed below. If this point turns out to be insurmountable, or just cumbersome, then the new waveform family of the present invention as shown in FIG. 11 may provide a viable alternative.

The anticipated difficulty arises from the fact that, in the waveforms shown in FIG. 10, data are written onto the back plane FETs while a saturating voltage is applied to the counter electrode. When this voltage is removed, the data level that remains applied to the LC pixel may not maintain the former data level. Indeed, the charge is redistributed between the pixel itself and the storage capacitor. The fraction of data voltage remaining as such, depends on the relative capacitance of these two capacitors, and on the saturating voltage amplitude. In principle, this should not be a problem, since data level losses may be anticipated. Therefore, one can calculate precisely the data size required for the fractional data remaining after saturation to be at the desired level. A conversion table may be prepared in advance, and included as an independent correction or as part of the gamma correction.

The problem may appear, or not, depending on the ratio between capacitances. Above a certain ratio, the voltage needed for the pixel to maintain eventually the correct data is higher than the maximum allowable range for the silicon backplane.

The two new waveforms proposed in FIG. 11 avoid this problem by inserting data before the saturating pulse is applied. Once all data are written, the whole display is erased and brought back to an intermediate data level with a voltage well 38. The drawback in this case, is that writing of data and erasing of the pixels are not simultaneous but consecutive. Therefore the overall “housekeeping” time increases about 100 ms. Moreover, the amplitude of the saturating pulses 39, 40 is higher. We have satisfactorily tested both of the waveforms shown in FIG. 11.

1. A method of driving an antiferroelectric liquid crystal display device which has an array of addressable pixels, each of which is defined between a pair of electrodes, the method comprising the steps of applying the following sequence of monopolar voltage pulses to at least one of the pair of electrodes which define at least one selected pixel:
(a) a first selection pulse operable to drive the selected pixel to a first activated state;
(b) a first bias pulse operable to cause the selected pixel to attain a predetermined grey scale level;
(c) a first erasure pulse of opposite polarity to that of the first selection pulse operable to erase the memory of selected pixel and to switch the pixel to a relaxed inactive state;
(d) a reset pulse operable to allow the pixel to reset in the relaxed state;
(e) a second selection pulse of opposite polarity to that of the first selection pulse operable to switch the selected pixel to a second activated state;
(f) a second bias pulse operable to cause the selected pixel to attain a predetermined grey scale level;
(g) a second erasure pulse of opposite polarity to that of the second selection pulse operable to cause the selected pixel to switch to the relaxed inactive state and erase the memory of the pixel; and,
(h) a reset pulse operable to allow the pixel to reset in the relaxed state.

2. A method according to claim 1 wherein the first and second bias pulse is of the same polarity as, but lower voltage than, respectively, the first and second selection pulses.

3. A method according to claim 1 wherein the first and second bias pulse is of the same polarity as, but higher voltage than, respectively, the first and second selection pulses.

4. A method according to any one of the preceding claims, wherein the reset pulses are at zero volts.

5. A method according to any one of the preceding claims, wherein data for the selected pixel is incorporated with the first and second selection pulses.

6. A method according to any one of the preceding claims wherein data for selected pixels are incorporated with the first and second bias pulses.

7. A method according to any one of claims 1 to 5 wherein data for non-selected pixels are incorporated with the bias pulses.

8. A method according to any one of the preceding claims wherein data for non-selected pixels are incorporated with the reset pulses.

9. A method according to any one of the preceding claims, wherein the display device is a passive matrix display device, and one of the electrodes of each pair of electrodes is constituted by one electrode of a first array of electrodes, and the other electrode of each pair is constituted either by an electrode common to all pairs of electrodes, or one electrode of a second array of electrodes, and the said pulses are applied sequentially to selected electrodes.

10. A method according to claim 8 wherein a first electrode of the pair of electrodes is maintained at a predetermined datum voltage level relative to the second electrode of the respective pair of electrodes, and the selection pulses, bias pulses, and erasure pulses are applied to the second electrode of the pair of electrodes.

11. A method according to claim 8, wherein the selection pulses and the bias pulses are applied to a first electrode of the pair of electrodes.

12. A method according to any one of claims 1 to 7 wherein the display device comprises an antiferroelectric liquid crystal material sandwiched between a reflective backplane comprising an array of addressable field effect Transistors (FETs), and one or more counter electrodes, thereby to define an array of addressable pixels, and the pulses are applied to one or more selected FETs and to the one or more counter electrodes thereby to drive selected pixels between an active state and the relaxed state.

13. A method according to claim 12 wherein data are applied to said bias pulses for driving the selected pixels to predetermined grey scale levels.

14. A method according to claim 12 or claim 13 wherein said selection pulses, bias pulses, erasure pulses and reset pulses are applied to selected FETs, and monopolar voltage first and second pulses are applied simultaneously to the counter electrode.

15. A method according to any one of claims 12 to 14 wherein the first pulse applied to the counter electrode has a pulse width that spans the combined pulse widths of the first selection pulse, the first bias pulse, the first erasure pulse, and the first reset pulse.

16. A method according to any one of claims 12 to 15 wherein the second pulse applied to the counter electrode has a pulse width that spans the combined pulse widths of the second selection pulse, the second bias pulse, the second erasure pulse and the reset pulse.

17. A drive system for an antiferroelectric liquid crystal display device that has an array of addressable pixels, each of which is defined between a pair of electrodes, the system comprising voltage generation means operable to apply the following sequence of monopolar voltage pulses to at least one of the pair of electrodes which define at least one selected pixel of the display device:
(a) a first selection pulse operable to drive the selected pixel to a first activated state;
(b) a first bias pulse operable to cause the selected pixel to attain a predetermined grey scale level;
(c) a first erasure pulse of opposite polarity to that of the first selection pulse operable to erase the memory of selected pixel and to switch the pixel to a relaxed inactive state;
(d) a reset pulse operable to allow the pixel to reset in the relaxed state;
(e) a second selection pulse of opposite polarity to that of the first selection pulse operable to switch the selected pixel to a second activated state;
(f) a second bias pulse operable to cause the selected pixel to attain a predetermined grey scale level;
(g) a second erasure pulse of opposite polarity to that of the second selection pulse operable to cause the selected pixel to switch to the relaxed inactive state and erase the memory of the pixel; and,
(h) a reset pulse operable to allow the pixel to reset in the relaxed state.

18. A drive system according to claim 17 wherein the first and second bias pulse is of the same polarity as, but lower voltage than, respectively, the first and second selection pulses.

19. A drive system according to claim 17 or claim 18 wherein the first and second bias pulse is of the same polarity as, but higher voltage than, respectively, the first and second selection pulses.

20. A drive system according to any one of the claims 17 to 19, wherein the reset pulses are at zero volts.

21. A drive system according to any one of claims 17 to 20, or wherein data for the selected pixel is incorporated with the first and second selection pulses.

22. A drive system according to any one of claims 17 to 21, wherein data for selected pixels are incorporated with the first and second bias pulses.

23. A drive system according to any one of claims 17 to 22, wherein data for non-selected pixels are incorporated with the bias pulses.

24. A drive system according to any one of claims 17 to 23, wherein data for non-selected pixels are incorporated with the reset pulses.

25. A drive system according to any one of claims 17 to 24, wherein the display device is a passive matrix display device, and one of the electrodes of each pair of electrodes is constituted by one electrode of a first array of electrodes, and the other electrode of each pair is constituted either by an electrode common to all pairs of electrodes, or one electrode of a second array of electrodes, and the said pulses are applied sequentially to selected electrodes.

26. A drive system according to any one of claims 17 to 25, wherein a first electrode of the pair of electrodes is maintained at a predetermined datum voltage level relative to the second electrode of the respective pair of electrodes, and the selection pulses, bias pulses, and erasure pulses are applied to the second electrode of the pair of electrodes.

27. A drive system according to any one of claims 17 to 26, wherein the selection pulses and the bais pulses are applied to a first electrode of the pair of electrodes.

28. A drive system according to any one of claims 17 to 25, wherein the display device comprises an antiferroelectric liquid crystal material sandwiched between a reflective backplane comprising an array of addressable Field Effect Transistors (FETs), and one or more counter electrodes, thereby to define an array of addressable pixels, and the pulses are applied to one or more selected FETs and to the one or more counter electrodes thereby to drive selected pixels between an active state and the relaxed state.

29. A drive system according to any one of claim 28, wherein data are applied to said bias pulses for driving the selected pixels to predetermined grey scale levels.

30. A drive system according to claim 28 or claim 29, wherein said selection pulses, bias pulses, erasure pulses and reset pulses are applied to selected FETs, and monopolar voltage first and second pulses are applied simultaneously to the counter electrode.

31. A drive system according to any one of claims 28 to 30, wherein the first pulse applied to the counter electrode has a pulse width that spans the combined pulse widths of the first selection pulse, the first bias pulse, the first erasure pulse, and the first reset pulse.

32. A drive system according to any one of claims 28 to 31 wherein the second pulse applied to the counter electrode has a pulse width that spans the combined pulse widths of the second selection pulse, the second bias pulse, the second erasure pulse and the reset pulse.

33. An antiferroelectric liquid crystal device that has an array of addressable pixels, each of which is defined between a pair of electrodes, the device including a drive system comprising a voltage generator means operable to apply the following sequence of monopolar voltage pulses to at least one of the pair of electrodes which define at least one selected pixel:
(a) a first selection pulse operable to drive the selected pixel to a first activated state;
(b) a first bias pulse operable to cause the selected pixel to attain a predetermined grey scale level;
(c) a first erasure pulse of opposite polarity to that of the first selection pulse operable to erase the memory of selected pixel and to switch the pixel to a relaxed inactive state;
(d) a reset pulse operable to allow the pixel to reset in the relaxed state;
(e) a second selection pulse of opposite polarity to that of the first selection pulse operable to switch the selected pixel to a second activated state;
(f) a second bias pulse operable to cause the selected pixel to attain a predetermined grey scale level;
(g) a second erasure pulse of opposite polarity to that of the second selection pulse operable to cause the selected pixel to switch to the relaxed inactive state and erase the memory of the pixel; and,
(h) a reset pulse operable to allow the pixel to reset in the relaxed state.

34. A liquid crystal device according to claim 33 wherein the first and second bias pulse is of the same polarity as, but lower voltage than, respectively, the first and second selection pulses.

35. A liquid crystal device according to claim 33 wherein the first and second bias pulse is of the same polarity as, but higher voltage than, respectively, the first and second selection pulses.

36. A liquid crystal device according to any one of claims 33 to 35, wherein the reset pulses are at zero volts.

37. A liquid crystal device according to any one of the claims 33 to 36, wherein data for the selected pixel is incorporated with the first and second selection pulses.

38. A liquid crystal device according to any one of claims 33 to 37, wherein data for selected pixels are incorporated with the first and second bias pulses.

39. A liquid crystal device according to any of claims 33 to 38 wherein data for non-selected pixels are incorporated with the bias pulses.

40. A liquid crystal device according to any one of claims 33 to 39 wherein data for non-selected pixels are incorporated with the reset pulses.

41. A liquid crystal device according to any one of claims 33 to 40, wherein the display device is a passive matrix display device, and one of the electrodes of each pair of electrodes is constituted by one electrode of a first array of electrodes, and the other electrode of each pair is constituted either by an electrode common to all pairs of electrodes, or one electrode of a second array of electrodes, and the said pulses are applied sequentially to selected electrodes.

42. A liquid crystal device according to claim 41 wherein a first electrode of the pair of electrodes is maintained at a predetermined datum voltage level relative to the second electrode of the respective pair of electrodes, and the selection pulses, bias pulses, and erasure pulses are applied to the second electrode of the pair of electrodes.

43. A liquid crystal device according to claim 41 or claim 42, wherein the selection pulses and the bias pulses are applied to a first electrode of the pair of electrodes.

44. A liquid crystal device according to any one of claims 33 to 40 wherein the display device comprises an antiferroelectric liquid crystal material sandwiched between a reflective backplane comprising an array of addressable Field Effect Transistors (FETs), and one or more counter electrodes, thereby to define an array of addressable pixels, and the pulses are applied to one or more selected FETs and to the one or more counter electrodes thereby to drive selected pixels between an active state and the relaxed state.

45. A liquid crystal device according to claim 44, wherein data are applied to said bias pulses for driving the selected pixels to predetermined grey scale levels.

46. A liquid crystal device according to claim 44 or claim 45, wherein said selection pulses, bias pulses, erasure pulses and reset pulses are applied to selected FETs, and monopolar voltage first and second pulses are applied simultaneously to the counter electrode.

47. A liquid crystal device according to any one of claims 44 to 45 wherein the first pulse applied to the counter electrode has a pulse width that spans the combined pulse widths of the first selection pulse, the first bias pulse, the first erasure pulse, and the first reset pulse.

48. A liquid crystal device according to any one of claims 44 to 47 wherein the second pulse applied to the counter electrode has a pulse width that spans the combined pulse widths of the second selection pulse, the second bias pulse the second erasure pulse and the reset pulse.
